(19) United States
(12) Patent Application Publication
(10) Pub. No.: US 2015/0164124 A1
(43) Pub. Date: Jun. 18, 2015

(54) FOOD PRODUCT FROM WHOLE BIRD LEG AND METHOD OF MAKING SAME

(71) Applicants: William Travis Warren, Fayetteville, AR (US); Maynard Neas Anderson, Fayetteville, AR (US); Nathan Wren Harris, Fayetteville, AR (US)

(72) Inventors: William Travis Warren, Fayetteville, AR (US); Maynard Neas Anderson, Fayetteville, AR (US); Nathan Wren Harris, Fayetteville, AR (US)

(21) Appl. No.: 14/107,123

(22) Filed: Dec. 16, 2013

(51) Int. Cl. A23L 1/315; A23B 4/06; A22C 21/00

(52) U.S. Cl. CPC A23L 1/3155; A22C 21/0023; A23B 4/06; A23V 2002/00

(57) ABSTRACT

The present invention relates to a method of strategically cutting a bird leg quarter to establish relative uniformity in the sizing, and resulting in a food product that is convenient and useful in commercial food and retail settings.

### GOVERNMENT CLAIM STATEMENT

None.

### FIELD OF THE INVENTION

The present invention relates to a conveniently sized bird leg quarter derived food product and method for making the same.

### BACKGROUND OF THE INVENTION

The present invention relates to a method of strategically cutting a bird leg quarter to establish relative uniformity in the sizing, and resulting in a food product that is convenient and useful in commercial food and retail settings. The established commercial market for conveniently sized edible portions of bird products is directed primarily to the white-meat industry. For example, food products, such as chicken fingers, are conveniently sized chicken breast meat products that have become ubiquitous in grocery stores and restaurants. Likewise, chicken nuggets are conveniently sized food chicken meat products that have been subjected to substantial processing to create shape, size and texture consistency. Much of the chicken nugget products are touted as being made from white meat. For example, there are breast tenders, boneless tenders, white meat nuggets, precisely sized breast filets, and many more commercial options for breast meat production. The substantial commercial marketing for the chicken fingers and chicken nugget market has created a market premium and emphasis upon white breast meat. As the commercial focus for these conveniently sized food products is almost exclusively on the breast meat, a cost of white meat is higher. Further, birds are bred for large breast meat in order to maximize the adaptability of the large white breast meat. Naturally then, the dark meat portion of the bird carcass comprising the bird legs has a much lower commercial value in the United States. The dark meat portion of the bird carcass includes the thigh and drum (also known as drumstick). In the commercial setting, there are only a limited number of ways to prepare and market the cuts for consumption. Typically, the thigh and drum is severed into two pieces by cutting through the thigh and drum joint. The marketplace has its commercial focus on selling either a thigh or a drum or package of the leg quarter product. The thigh and drum cuts are therefore driven by the anatomy of the bird, i.e., the length of the thigh or drum and the bones contained therein. This is in sharp contrast to the widespread use of boneless breast meat having many commercial product forms.

The present invention opens the doorway for the commercial marketplace to have many more options relative to the size and market products that are consumer-friendly. Dark meat can now be a reasonable alternative to the white meat dominance in the United States. The present invention is expected to gain widespread consumer acceptance due to the affordability of the dark meat being marketed in similar commercial channels currently occupied almost exclusively by white meat. The method of the present invention is relatively quick and easy to carry out and results in a food product which is both appetizing, convenient for the consumer to handle, and represents a substantial departure from the typical treatment of the thigh and leg cuts. The present invention opens many more commercial opportunities for the dark meat portions of the bird to become as widely commercially adaptable to provide a tasty, convenient, and easy to prepare meat product.

### SUMMARY OF THE INVENTION

The present invention provides a method of cutting a bird leg quarter comprising the thigh connected to the drum at the drum/thigh joint. Severing the drum from the thigh is well known, but that is the extent of the commercial treatment of the dark meat portions of the bird. The present invention thereafter includes the additional steps of trisecting the drum and quadrisecting the thigh portions using preferential cuts to maximize the available meat, minimize the inclusion of bone, and exclude the unusable or otherwise inedible portion of the drum region. The resulting cut products will then be subjected to marinade and prepared for commercial presentation.

### BRIEF DESCRIPTION OF THE DRAWING

The foregoing summary, as well as the following detailed description of preferred embodiments of the invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown. In the drawing:

FIG. 1 is a perspective view of an uncooked, leg quarter 1, and shows anatomical relationship to the leg quarter 1.

FIG. 2 is a perspective view of an uncooked, leg quarter 1, and shows the preliminary cut lines to the leg quarter 1.

FIG. 3 is a perspective view of an uncooked, leg quarter 1, and shows the resulting cut pieces

### DESCRIPTION OF THE PREFERRED EMBODIMENT

Certain terminology is used herein for convenience only and is not being taken as a limitation on the present invention. In the drawings, the same reference numerals are employed for designating the same elements throughout the several figures. The following definitions are provided to promote understanding of the invention:

Drum—the portion of the chicken containing the flesh and connective tissue surrounding and including the Fibula and Tibia bones.

Thigh—the portion of the chicken containing the flesh and connective tissue surrounding and including the Femur bone.

Drum/Thigh Joint—the portion of the whole chicken containing the connective tissue comprising tendons, ligaments, cartilage, and connective tissue otherwise having the anatomical function of connecting the Drum to the Thigh.

Leg quarter—the portion of a chicken carcass consisting of a Drumstick, Kneecap, Thigh, and may include all or a portion of the hipbone otherwise remaining connected to the thigh.

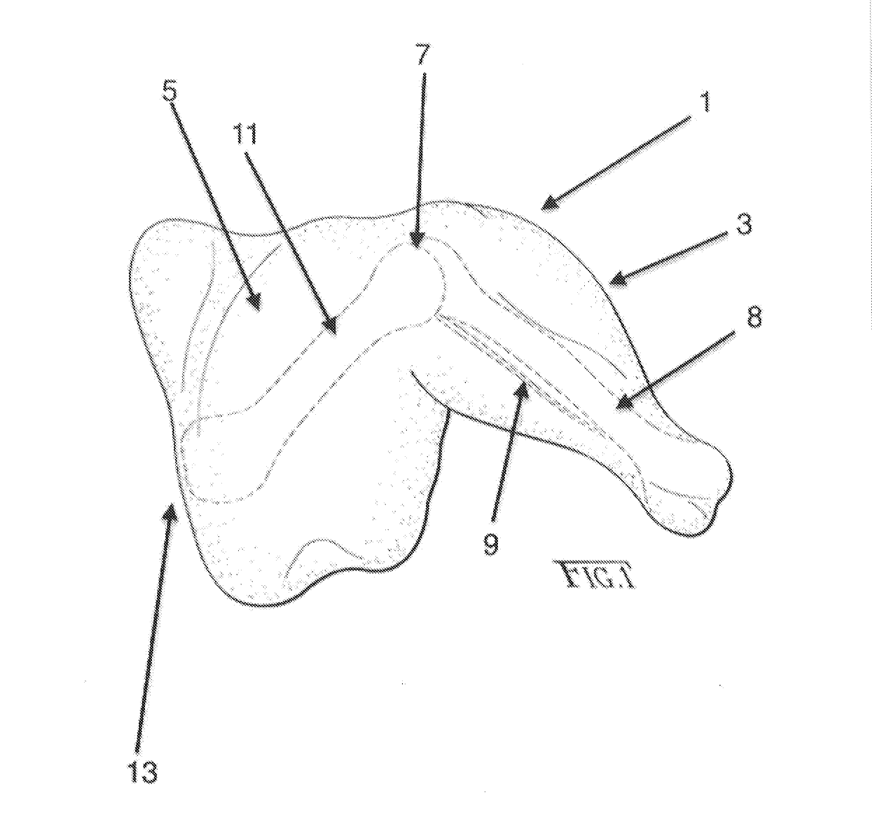

FIG. 1 shows a leg quarter 1. The leg quarter 1 has a Drum 3 generally containing the flesh and connective tissue surrounding and including the Fibula 8, and Tibia bone 9, and a thigh 5 generally containing the flesh and connective tissue surrounding and including the Femur bone 11. Adjoining the Drum 3 and thigh 5 is the Drum/Thigh Joint 7, and also part of the leg quarter may be a Hipbone 13. The Hipbone 13 is not shown in detail in FIG. 1 but rather the indicators show the approximate location of the Hipbone 13. It is not necessary to remove any skin to practice the invention, and FIG. 1 illustrates the leg quarter 1 having skin covering.

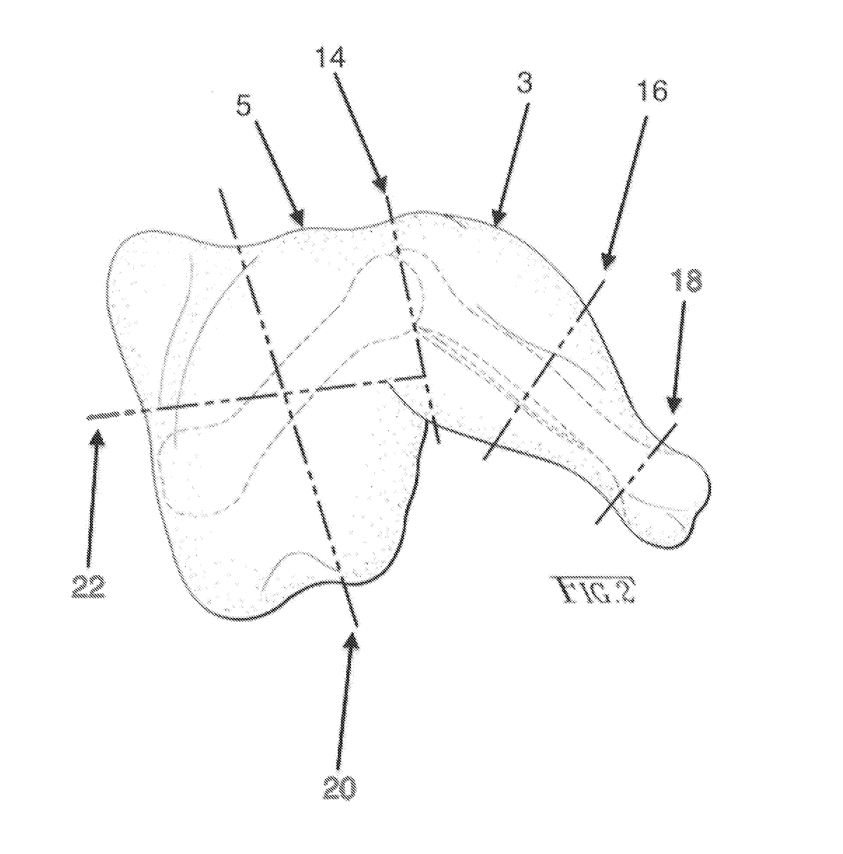

FIG. 2 illustrates a leg quarter 1 having dashed lines to illustrate certain cut lines. Drum/Thigh Joint Cut 14 is a preferred first cut as it separates the Drum 3 from the thigh 5 and permits easier handling and control to facilitate the remaining cuts. The T/F Transverse Cut 16 is made by making a transverse cut to the tibia and fibula at a desired location. The preferred embodiment for the Transverse Cut 16 is generally bisecting the length of the Drum 3. FIG. 2 illustrates a T/F Head Discard Cut 18 a Femur Trans aligned Cut 20, and a Femur Long aligned Cut 22.

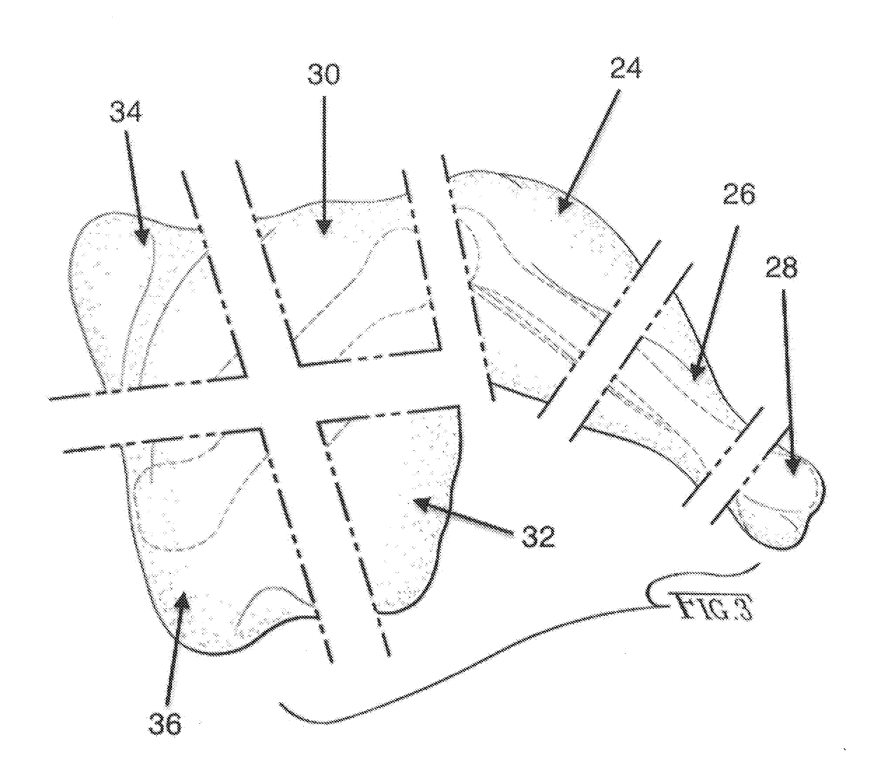

FIG. 3 illustrates a leg quarter 1 having dashed lines to illustrate cut lines following the separation of the leg quarter 1 into at least seven discrete sizing labeled Drum 24, DrumB 26, DrumC 28, ThighA 30, ThighB 32, ThighC 34, and ThighD 36.

When starting with a leg quarter 1 shown in FIG. 1, the first step in the process of the present invention is to establish the proper orientation as shown in FIG. 1 to begin making cuts to the leg quarter 1. Once the leg quarter 1 is properly oriented, a longitudinal cut is made across the Drum/Thigh Joint Cut 14 to separate the Drum 3 from the thigh 5. This step permits easier handling and control by the user to make the remaining cuts in this process. The second step in the process is to trisect the Drum 3, which is accomplished by making a T/F Transverse Cut 16. This transverse cut to the tibia and fibula at a desired location is illustrated in FIG. 1. The result of this T/F Transverse Cut 16 is DrumA 24, shown in FIG. 3. The preferred embodiment for the Transverse Cut 16 is generally bisecting the length of the Drum 3, although it may be advantageous to make the T/F Transverse Cut 16 closer to the Drum/Thigh Joint Cut 14, judging from the amount of flesh on the Drum 3. The fourth step is to make a T/F Head Discard Cut 18. The result of this cut is the creation of DrumB 26 and DrumC 28. In the fifth step is the quadrisecting of the Thigh 5. The quadrisecting is accomplished with a Femur Trans aligned Cut and a Femur Long aligned Cut 22, and these cuts produce ThighA 30, ThighB 32, ThighC 34, and ThighD, 36.

The resultant cut products (i.e., DrumA 24, DrumB 26, DrumC 28, ThighA 30, ThighB 32, ThighC 34, and ThighD, 36.) may be marinated and oven-roasted, or cooked in seasonings, barbecue sauce, or hot wing sauce. Other methods for cooking poultry products may be used instead. The resultant products, when formed from a typical leg quarter 1 contains about 3-5 ounces of meat. With this approach, the resultant cut products is convenient and tasty eating snack foods, suitable for bars, hors d'oeuvres, and the like. These cut products allow for better use of leg quarter 1 than present processing methods. Presently, the leg quarter 1 is divided only into the Drum 3 and thigh 5. Presently, there is no effort when serving the Drum 3 to establish reasonable sized pieces; it is sold as an entire drumstick. Additionally, there is no commercial effort when serving the Drum 3 to remove the DrumC 28 from the remainder of the Drum 3. Removal of DrumC 28 allows for removal of an amount of cartilage and other inedible elements that are associated with the joint connecting the Drum 3 to the poultry feet.

From the foregoing description, it can be seen that the present invention comprises a food product and method of making the same. It will be appreciated by those skilled in the art that changes and modifications may be made to the above-described embodiment without departing from the broad inventive concepts thereof. For instance, the cut producing the DrumC 28 resulting product could be omitted to produce only DrumA 24 and DrumB 26, which is has substantial commercial appeal. It is therefore understood that the present invention is not limited to the particular embodiment disclosed, but it is intended to include all modifications and changes which are within the spirit and scope of the invention, as defined by the appended claims.

We claim:

1. A food product comprising:
an unprocessed bird leg quarter having a thigh having a femur bone and a drum having a tibia and fibula, both joined at a thigh/drum joint;
a first transecting cut line through the thigh/drum joint, severing the thigh from the drum;
a second transecting cut line through the drum at the approximate mid-point of the drum;
a third transecting cut line through the drum, transecting the drum near the opposite end of the thigh/drum joint;
a fourth longitudinal cut line through the thigh, substantially transecting the femur bone; and,
a fifth cut line made substantially lengthwise through the remaining thigh portions, substantially aligned with the femur bone.

2. A method of making a convenient sized meat product from a bird, comprising the steps of:
cutting a bird leg quarter with a thigh having a femur bone and a drum having a tibia and fibula, joined at a thigh/drum joint;
cutting a transecting cut line through the thigh/drum joint, thereby severing the thigh from the drum;
cutting a transecting cut line through the drum at the approximate mid-point of the tibia and fibula bones;
cutting a transecting cut through the thigh at the approximate mid-point of the thigh, thus transecting the femur bone; and,
cutting a longitudinal cut line through the thigh, substantially aligned with the femur bone, and;
collecting the resulting convenient sized meat product.

3. The method of claim 2, further comprising the step of marinating the resulting convenient sized meat product.

4. The method of claim 2, further comprising the step of applying a glaze to the resulting convenient sized meat product.

5. The method of claim 2, further comprising the step of flash freezing the resulting convenient sized meat product.

6. The method of claim 2, further comprising the step of fully cooking the resulting convenient sized meat product.

7. A method of making a convenient sized meat product pieces from a bird, comprising the steps of:
cutting a bird leg quarter with a thigh having a femur bone and a drum having a tibia bone and fibula bone, such thigh and drum being joined at a thigh/drum joint, the drum having a point proximal to, and a point distal to, the thigh/drum joint;
cutting a transecting cut line through the thigh/drum joint, thereby severing the thigh from the drum;
cutting transectionally through the drum at the approximate mid-point of the drum;
cutting transectionally through the drum at a point distal to the thigh/drum joint to remove a predetermined amount of the drum;
cutting transectionally through the thigh at the approximate mid-point of the thigh, thus transecting the femur bone; and
cutting longitudinally through the thigh, substantially aligned with the femur bone; and,
collecting the eight resulting conveniently sized meat product pieces.

8. The method of claim 7, further comprising the step of marinating the resulting convenient sized meat product pieces.

9. The method of claim 7, further comprising the step of applying a glaze to the resulting conveniently sized meat product pieces.

10. The method of claim 7, further comprising the step of flash freezing the resulting conveniently sized meat product pieces.

11. The method of claim 7, further comprising the step of fully cooking the resulting conveniently sized meat product.
